(19) United States
(12) Patent Application Publication
(10) Pub. No.: US 2011/0094840 A1
(43) Pub. Date: Apr. 28, 2011

(54) Electric highway system

(76) Inventor: Masami Sakita, San Francisco, CA (US)

(21) Appl. No.: 12/589,601

(22) Filed: Oct. 26, 2009

(51) Int. Cl. B60L 9/00; G06G 7/76; H02G 9/00

(52) U.S. Cl. 191/2; 701/119; 701/207; 191/22 C; 174/39

(57) ABSTRACT

The electric highway includes at least one electrified lane that may be separated from other non-electrified lanes by a non-elevated strip of dividers, a roadside subsystem that includes a system operation monitoring center that monitors system operation; a plurality of roadside conductor assemblies, each of which includes at least one roadside conductor laid within a coaxial pipe made of a non-magnet field shielding material, and its/their housing in the traffic lane; a roadside part of an on-board part of a lateral location sensor; a plurality of roadside controller each of which includes a power supply assembly, at least one communication device housed in a roadside box, and a plurality of roadside posts with a camera affixed to it. The electric highway system is monitored continuously at the system operation monitoring center.

### FIELD OF THE INVENTION

This invention relates generally to an electric highway system.

### BACKGROUND OF THE INVENTION

Electric power has been used to energize vehicles running on the highway for a long time as seen in the trolley bus on the city street. The trolley bus is quiet, does not emit exhaust gas, and its current collection (or power transfer) method that uses the current collector poles and the overhead wires is very energy efficient. This current collection method, however, is neither designed for high speed operations nor applicable to the ordinary automobile.

The electrified highway that does not use direct electrical conductive connection was tested in 1990 by the PATH (California Partners for Advanced Transit and Highways) administered at the Institute of Transportation Studies of the University of California at Berkeley in collaboration with Caltrans of the State of California. In the PATH experiment, electric power was supplied to the test vehicle (an electric bus) by electromagnetic induction system that includes an iron core in both primary and secondary conductors. It is reported that the overall system efficiency was about 60%, but the researchers believed that the efficiency can be improved by 10 to 20%.

Independently, Boys et al at UniServices of the University of Auckland developed a power transfer system by induction called the IPT (Inductive Power Transfer) that uses primary conductors with no cores and secondary conductors with a ferrite core carrying resonant current in the order of 10 kHz (see U.S. Pat. Nos. 5,293,308, 5,528,113 and 5,619,078 all by Boys et al). The technology developed by Boys et al is widely used for transporting vehicles in assembly lines for automobile manufacturing plants and transporting cargos in warehouses. These systems use a primary conductor comprising a series of alternating litz wire pairs and resonating capacitors, and a secondary conductor wound around a ferrite core and a resonating capacitor underneath the vehicle. A light rail system developed by Bombardier Transportation GmbH that uses seemingly a similar technology as that developed by Boys et al is reported to be on the market by 2010.

The electromagnetic induction power transfer is definitely a more suitable power transfer method in energizing vehicles on the highway than that uses the overhead wires because it can be used with all types of vehicles tall and short. In addition, not having the overhead wires is more aesthetically pleasing. According to a Bombardier brochure, its Primove light rail system equipped with Mitrac Energy Saver regenerative braking system is energy efficient, and is designed to provide 250 kW of continuous power output for a typical 30 m long rail vehicle, and performance can vary from 100 to 500 kW depending on the length and number of vehicles, topographic conditions and range of application. We believe that this indicates that there is a good possibility that the same electromagnetic induction power transfer technology may be used as a means to energize automobiles operated on the highway. The electromagnetic induction power transfer technology, however, probably will be more expensive to build, and more susceptible to failures than that uses the overhead wires, and when failed, could be more time consuming to repair, and thus will still need improvements.

### OBJECTS OF THE INVENTION

An object of this invention is the provision of an electric highway system that is least costly to build, not susceptible to failures, and if failures occur, can be easily detected and repaired. In order to achieve the object, the induction power transfer system in the preferred embodiment uses a simple but robust (or not susceptible to failures) and easy to repair conductor bed design, and is equipped with a system wide vehicle-level monitoring system for early detection of system failures and operational irregularities.

An object of this invention is the provision of an electric highway system that is highly energy efficient to operate and that has a higher capacity per electrified lane than that of the ordinary highway. The higher highway capacity will lead to less congestion and less need for construction of the highway, and thus will result in even higher energy savings and CO2 reduction. In order to achieve the object, the roadside subsystem of the electric highway system includes means to assist automatic operation of coupled vehicles in the electrified lane of the highway system.

The automated operation of coupled vehicles should greatly reduce the possibilities of accidents in the electrified lane. Possibility of collisions should not exist once the vehicles are coupled, and other possible causes of accidents such as failed vehicle, manually operated vehicle, and effects of bad weather and road conditions may be reduced by execution of predefined treatments for each event: failed vehicles while in operation may be greatly reduced mostly by examining the vehicle's diagnostics records every time it enters into the electrified lane; manually driven vehicles driven into the electrified lane and creates accidents may be prevented mostly by strict monitoring of the system operation and discouragement of the use of the electrified lane by the drivers of the manually operated vehicles; and negative effects of the weather on sight distance and road surface conditions can be reduced by imposing slower maximum allowable speeds at each road segment as needed.

### SUMMARY OF THE INVENTION

The preferred embodiment of the electric highway system of the present invention includes a roadside subsystem, a centralized system operation monitoring center and an account processing center that may be located in the same facility as the system operation monitoring center, a roadside part of a lateral location sensor, a communication network that connects the system operation monitoring center, the account processing center and the roadside subsystem, at least one electrified lane, at least one power source such as a feeder station, and power cables that connect the power source and the roadside subsystem.

The roadside subsystem includes a plurality of roadside conductor assemblies, each of which includes at least one roadside conductor longitudinally disposed in the traffic lane; a plurality of roadside controllers housed in a roadside box wherein which controller includes a power supply assembly to the roadside conductor and a power meter, and at least one communication means; a plurality of roadside posts with a camera affixed to it.

The electrified lane is used by a plurality of vehicles of at least first type, and possibly vehicles of second type. The vehicle of first type includes an electric motor, at least one energy storage means, an on-board power pick up means assembly, at least one coupler, at least one power meter, at least one on-board computer, an on-board part of a lateral location sensor, an on-board lateral position control means, a longitudinal distance/speed sensor, a longitudinal position control means, and at least one communication means. The vehicle of second type is identical to that of first type except that it is not equipped with the coupler.

### BRIEF DESCRIPTION OF THE DRAWINGS

The above description and other objects and advantages of this invention will become more clearly understood from the following description when considered with the accompanying drawings. It should be understood that the drawings are for purposes of illustration only and not by way of limitation of the invention. In the drawings, like reference characters refer to the same parts in the several views:

FIG. 1 is a schematic representation of a preferred embodiment of the present invention;

FIG. 2 is a rear view of a roadside conductor assembly, a car equipped with an on-board power pick up means assembly, and a roadside post;

FIG. 3A is a longitudinal cross-sectional view of a conductor assembly, FIG. 3B a lateral cross-sectional view taken along A-A of FIG. 3A, and FIG. 3C a lateral cross-sectional view taken along B-B of FIG. 3A;

FIG. 4A is a schematic diagram showing the arrangement of roadside conductors for a 3-phase delta connection system, FIG. 4B a lateral cross-sectional view of a conductor assembly of a different design, and FIG. 4C a schematic diagram of a factory made conductor in the inner tube;

FIG. 5A through 5C are sample graphical displays at the system operation center: FIG. 5A showing power meter readings at the roadside conductor assembly segments, FIG. 5B showing power meter readings on the vehicles in the roadside conductor assembly segments, and FIG. 5C showing the ratio between the on-board reading/roadside reading;

FIG. 6A through 6C are sample graphical displays at the system operation center: FIG. 6A showing vehicle count in the roadside conductor assembly segments, FIG. 6B showing registered vehicles in the roadside conductor assembly segments, FIG. 6C showing irregularity between the roadside vehicle count and the registered vehicles;

FIG. 7A through 7C are sample graphical displays at the system operation center: FIG. 7A showing vehicle count in a selected roadside conductor assembly segment, FIG. 7B showing registered vehicles in the selected roadside conductor assembly segment, FIG. 7C showing irregularity between the roadside vehicle count and the registered vehicles in the selected roadside conductor assembly segment;

FIG. 8 is a sample graphical display at the system operation center showing time-space diagram of vehicle trajectories at the entrance point to the roadside assembly segments;

FIG. 9A is a lateral cross-sectional view of a roadside conductor in the conductor bed segment and FIG. 9B a lateral cross-sectional view of roadside conductors in the expansion segment, of an alternative embodiment of the roadside conductor assembly;

FIG. 10 is a schematic representation of a coupling/decoupling terminal;

FIG. 11 is a schematic representation of an alternative embodiment of the present invention, in which embodiment the roadside conductors are overhead wires;

FIG. 12 is a rear view of a truck equipped with a pantograph assembly and a roadside post; and

FIG. 13 is a side view of a truck equipped with a pantograph assembly and the roadside post.

### DETAILED DESCRIPTION OF THE INVENTION

### Preferred Embodiment

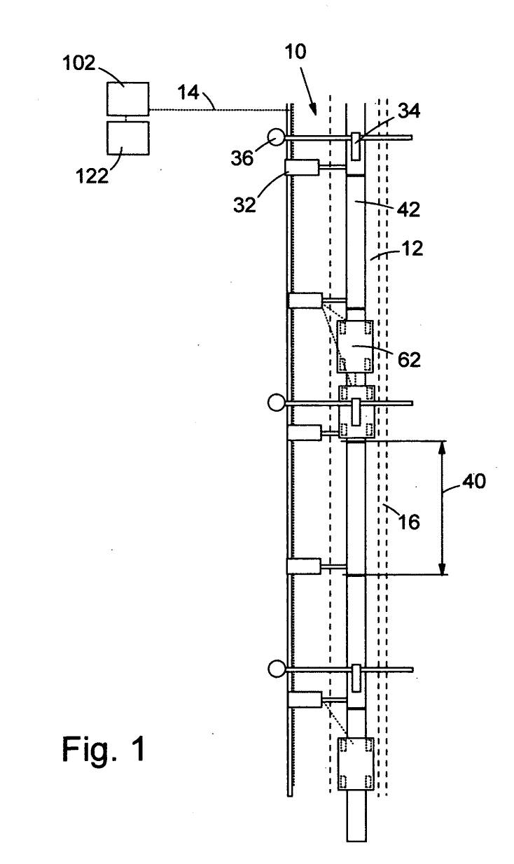

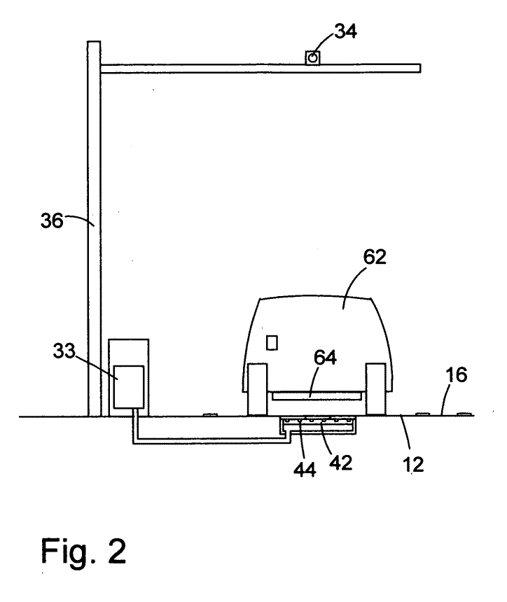

As shown in FIGS. 1 and 2, the preferred embodiment of the electric highway system of present invention includes a roadside subsystem 10; a centralized system operation monitoring center 102 and an account processing center 122 that may be located in the same facility as the system operation monitoring center; a communication network 14 that connects the roadside subsystem, the system operation monitoring center, and the account processing center and the roadside subsystem; at least one electrified lane 12 that may be separated by a non-elevated divider strip 16 from other non-electrified lanes; at least one power source such as a feeder station, and power cables that connect the power source and the roadside subsystem.

The roadside subsystem 10 includes a plurality of roadside conductor assemblies 42 disposed longitudinally serially in the electrified lane, each of which conductor assemblies includes at least one roadside conductor 44; a plurality of roadside controllers 33 each housed in a roadside box 32 wherein which controller includes a power supply to the roadside conductor 44, a power meter that is able to measure voltage and current of electricity per conductor, a power switch to the roadside conductors, and at least one communication means; a plurality of roadside posts 36 with a camera 34, which is possibly a video camera, affixed to it; and a roadside part of a lateral location sensor.

The electrified lane 12 is used by a plurality of vehicles 62 of at least first type, and possibly by vehicles of second type. The vehicle of first type, which is equipped with an on-board power pick up means assembly 64 includes an electric motor, at least one energy storage means, at least one power meter, at least one coupler, at least one on-board computer, a means to receive GPS coordinates, an on-board part of a lateral location sensor, a lateral position control means, a longitudinal distance/speed sensor, a longitudinal position control means, and at least one communication means. The vehicle of second type is identical to that of first type except that it is equipped with no couplers.

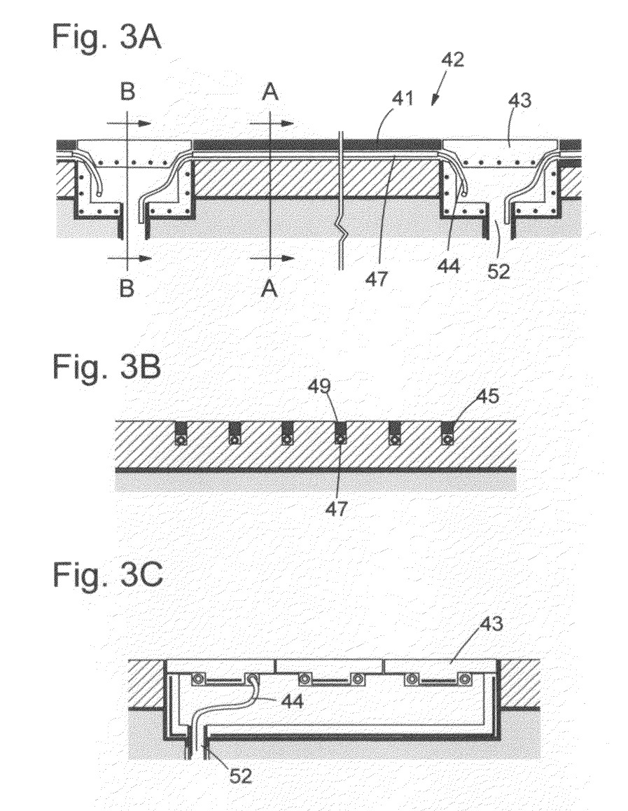

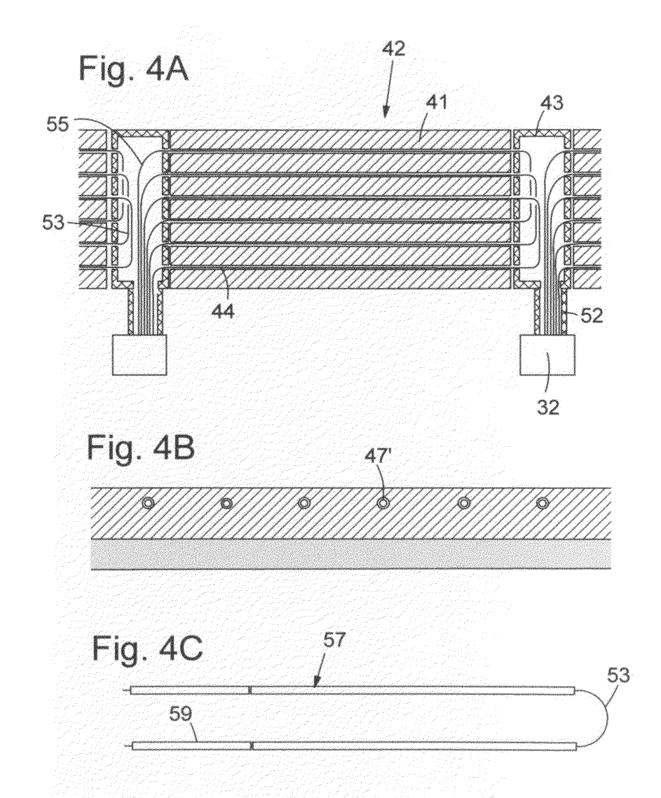

FIGS. 3A, 3B, 3C and 4A illustrate roadside conductors and their housing for a 3-phase delta connection inductive power transfer system developed by Covic and Boys at UniServices of the University of Auckland. Covic and Boys showed that the 3-phase delta connection inductive power transfer system is able to pick up significantly higher power than the single phase AC system. The preferred embodiment of this invention assumes the use of the 3-phase delta connection roadside conductors. (Note that only 1 out of 6 conductors is shown in FIGS. 3A and 3B for illustration purpose.)

The roadside conductor assembly 42 includes a conductor bed 41 and an expansion box 43. The conductor bed 41 and the expansion box 43 are disposed longitudinally in an alternate order generally in the middle of the electrified lane. The conductor bed 41 includes at least one longitudinally extending groove 45 cut on the pavement surface in which groove a non-magnetic field shielding coaxial tube assembly 47 is placed on a layer of caulking material that firmly adheres the tube assembly to the bottom and the sidewalls of the groove. The coaxial tube assembly 47 comprises an external coaxial tube, and a relatively flexible (or bendable) internal tube, and space in between them. The space between the two tubes will be kept empty. A conductor 44, preferably a film coated litz wire, is placed inside the internal tube. The coaxial tubes preferably have a square cross section, and the litz wire too preferably will have a square cross section, or two litz wires of a rectangular cross section that together may fill up the space of the internal tube of a square cross section.

The space above the external tube is filled with material 49 that does not shield magnetic field. The expansion box has concrete walls and a concrete cover with reinforcement steel bars or steel mesh, and has an opening at the bottom for a conduit 52 that connects the expansion box and the roadside box 32. The expansion box 43 holds connecting (or looping) 53 ends of the conductors and terminating ends 55 of the conductors that extends to the power supply in the roadside box. The number of conductors can be two or even one for a single phase AC or a DC current system developed by Boys et al as shown in U.S. Pat. No. 5,619,078.

The length of the roadside bed (and the coaxial tubes) may be different depending on the output capacity of the roadside conductor assembly, and different circumstances. If the output capacity of the roadside conductor assembly, for example, is 250 kW as that in the Bombardier light rail system, the conductor bed may be about 20 meters long in the normal highway section, and may become shorter in segments with steep slopes, wherein 250 kW is assumed to be about the amount of power used by five mid-size cars driving on the highway under normal conditions. Under this design, however, the large truck such as a semi truck may not be allowed to couple together, and if a large truck stops in a close distance from a vehicle ahead of it, at least some of them may have to use power stored in the on-board battery to start up the motor because the roadside conductor assembly may not, have enough power output for all vehicles on it. Shortening of the conductor bed, for example, to 8 meters, which is about the length of the shortest large truck, will allow coupling of large trucks, and no vehicles in this system will have to use the stored power in the on-board battery. Alternatively, the large truck may use power supplied by the overhead wire system that may be used in conjunction with the inductive power transfer system (see Alternative Embodiments C and E). It is also possible to make the conductor bed segment very short, for example, as short as 4 meters, so that only one non-two-wheel vehicle of any type can take power from it at one time. In the system that has conductor bed shorter than possibly 40 meters, the roadside post with a camera will not have to be installed at every conductor segment.

Alternatively, the groove that contains the coaxial tube assembly 47 may be paved over (see FIG. 3B). Or further alternatively, the coaxial tube assembly 47′ may be directly buried in the pavement at a specified depth from the pavement surface (see FIG. 4B). In the latter case, coaxial tubes with round cross sections and a litz wire with a round cross section inside instead of rectangular tubes and a litz wire with a square or rectangular cross section may be used.

If in case the conductor is damaged, first, the pair of inner tubes that contain connected damaged conductors inside will be taken out, and then, a pair of new inner tubes with replacement conductors inside that is prepared at the factory and taken to the site will be inserted into the external tubes (see FIG. 4C). The connecting ends 57 of the conductors that are enclosed in temporary inner tubes 59 will be thrown away after installing the conductors. It is assumed that inserting a conductor of into a tube by itself probably will be difficult if not impossible, and digging out a tube with a conductor inside from the groove will be time consuming, and may even damage the groove walls if not done carefully. Using a square cross section is to make the groove narrower than using a round cross section wire.

The on-board power pick up means assembly includes at least one power pick up means, and a capacitor. The power pick up means affixed to the bottom of the vehicle according to Boys et al includes a plurality of coils wound around a generally plate-shaped core in such a manner that each of the coils will be located directly above a roadside conductor while the vehicle runs in the electrified lane.

When the vehicle 62 passes by the roadside box 32, the vehicle receives a signal requesting for payment information from the roadside controller. If the vehicle transmits valid payment information including the vehicle ID, on-board power meter reading, account number, etc., the roadside controller, will switch on the roadside conductors if they have not yet been switched on, and will transmit back to the vehicle the power charge information including date, time, vehicle ID, roadside box ID, the on-board power meter reading, etc. in return. The means and method similar to that used in the toll payment system that uses an RFID technology may be used for this purpose.

The roadside box 32 that contains the roadside controller 33 may be installed at a roadside location that is at some distance upstream of the beginning of the conductor assembly segment 40 to ensure that the conductors will have been already switched on by the time the vehicle reaches the beginning point of the conductor assembly segment 40. If the information sent from the vehicle 62 to the roadside controller is not satisfactory, the roadside controller informs the vehicle to get out of the electrified lane, and transmits the vehicle ID (or whatever the vehicle has sent as the vehicle ID) to the system operation monitoring center and the vehicles near by. The system operation monitoring center 102 in turn transmits the vehicle ID to all vehicles in the system through the roadside controllers a warning that the vehicle with the ID should not be electronically connected together or physically coupled together. This process repeats for every vehicle at every roadside controller 33.

The roadside controller transmits power meter readings to the system operation monitoring center 102 every small time increment continually. The information will be sent to the system operation monitoring center 102 for monitoring the conductor assembly. If the roadside power meter readings indicate that the power used in the roadside conductor assembly becomes zero as the vehicle that has been taking electricity from the roadside conductors leaves the electrified lane, the roadside controller may switch off power to the roadside conductors.

Right after the roadside controller transmits the confirmation data to the vehicle, the vehicle transmits its current speed and acceleration/deceleration rate back to the roadside controller. In return, the roadside controller transmits the information from the vehicle together with its roadside box ID to the system operation monitoring center, and then, next, transmits the allowable maximum speed to the vehicle that has been determined by the system operation monitoring center.

The preferred embodiment of the electric highway and the vehicle may use a lateral location sensing technology developed by the PATH. The on-board part of the lateral location sensor is at least one pair of magnetometers affixed to the front end and possibly at least one pair of magnetometers affixed to the rear end of the vehicle symmetrically arranged about the vehicle's centerline and faced generally outward. The roadside part of the lateral location sensor is a plurality of magnetic cells placed in drilled holes in the pavement along the lane markings of the electrified lane with generally equal longitudinal spacing. The on-board part of the lateral location sensor estimates the amount of deviation of the lateral center of the vehicle at the front end and possibly the rear end from the centerline of the electrified lane, wherein the estimation of deviation is based on observed correlation between the normalized difference of the strengths of the magnetic fields in a (right/left) pair of magnetometers and the actual deviation of the center point of the vehicle from the centerline of the electrified lane.

The lateral position control means includes a computer-controller means to rotate the steering wheel shaft. While in the electrified lane, the on-board computer computes the amount of rotational angle the motor should make based on the deviation of the front center point and possibly the rear center point of the vehicle from the imaginary centerline of the electrified lane. The lateral position control means should be able to steer the vehicle in such a manner that the center point of the vehicle at the front and rear ends will coincide with the imaginary center line of the electrified lane.

While driving in the ordinary highway lane next to the electrified lane, if the driver wants to get into the electrified lane, and if he/she wants the vehicle to be couplable to other vehicles, he/she presses “Automatic-Couplable” button on the dashboard when he/she finds the vehicle of the same coupler height/size with extended coupler in the electrified lane, and if he/she wants the vehicle to be non-couplable, he/she presses “Automatic-Non-Couplable” button on the dashboard of the vehicle. The vehicle will transmit the payment information to the nearest roadside box including the vehicle ID and a digital certificate that shows diagnostics results generated by the on-board computer to prove that the vehicle is in good condition for driving in the automatic mode in the electrified lane. The to-be-leading vehicle in the electrified lane to which the “present” vehicle will be coupled will receive an automatically generated message from the “present” vehicle that “a vehicle wants to couple,” and unless the system advises not to do so (see the following paragraph), the to-be-leading vehicle will send an automatically generated message to acknowledge it.

If the vehicle could not show valid payment information or a valid certificate, the roadside controller will transmit a warning to the vehicle that could not show valid payment information or a valid certificate not to get into the electrified lane, and also transmit the vehicle ID to the system operation monitoring center so that the center is able to transmit a message to the vehicles near-by not to couple with the vehicle with the specified ID physically or electronically.

If a vehicle operating in the electrified lane finds a vehicle that does not communicate with it, it will report to the roadside controller every time the reporting vehicle passes by the roadside controller. This process is done automatically by the vehicle without the driver taking any action.

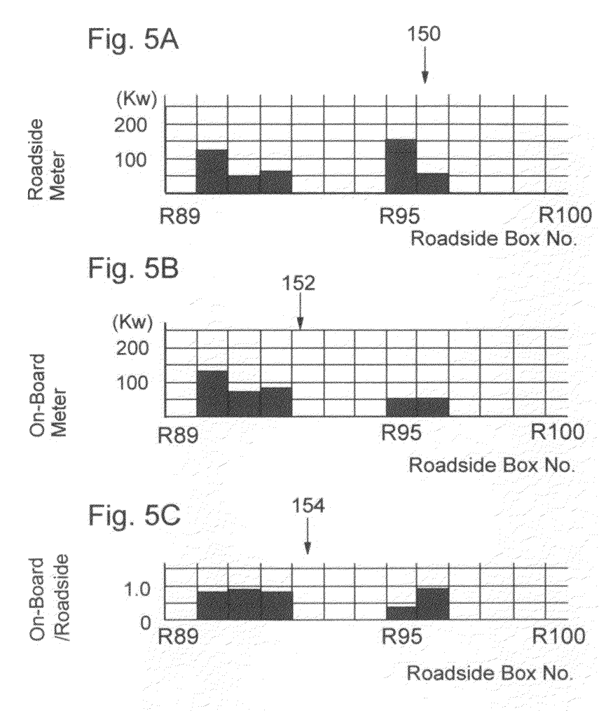

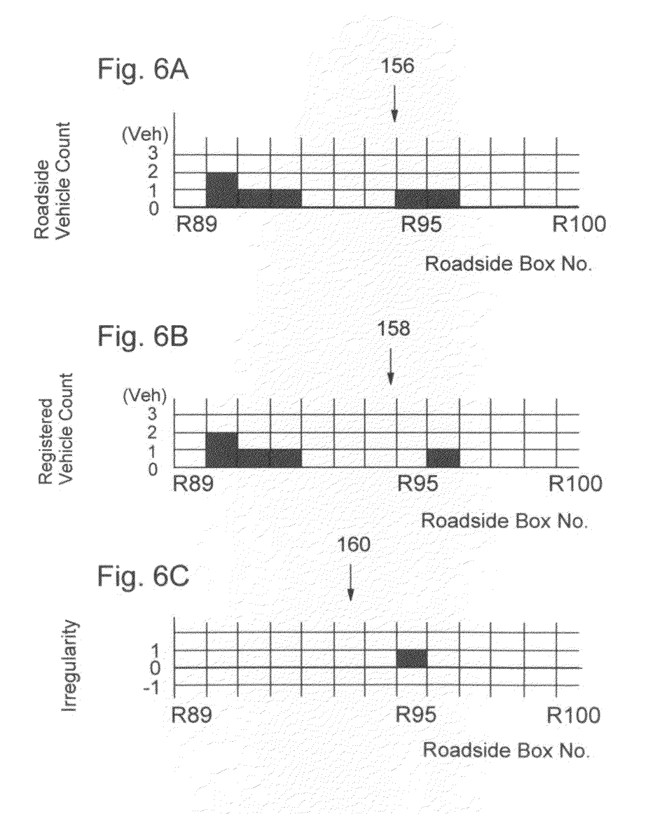

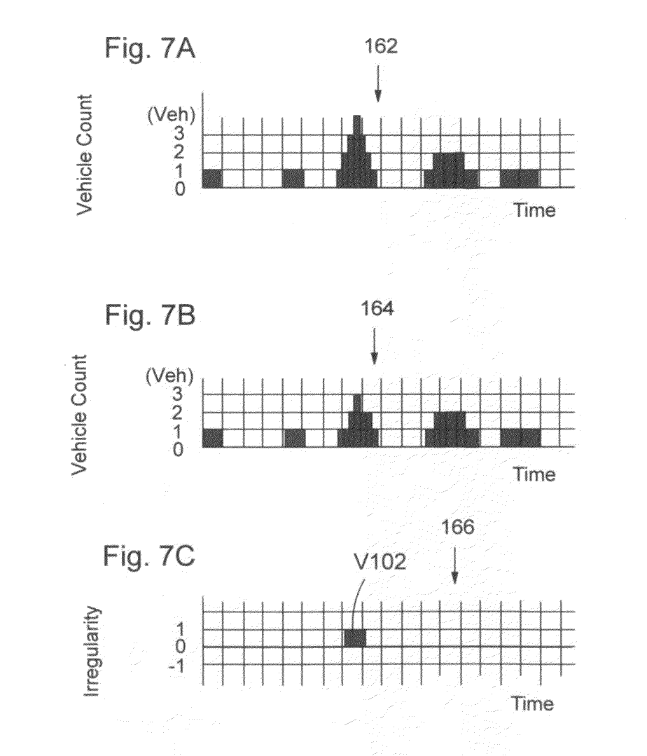

At the system operation monitoring center 102, the data sent from the roadside controllers 33 are processed and may be graphically shown on one or more display monitors on an on-line real time basis for observation by the system operation monitoring personnel. Some of sample graphical displays of hypothetical examples are shown in FIGS. 5A through FIG. 8. FIGS. 5A and 5B show meter readings 150 at the roadside conductor assembly segments and on-board meter readings 152 (based on the data reported from the vehicles to the roadside controllers 33) that pass through the roadside conductor assembly segments, and FIG. 5C shows the ratio 154 between them. FIGS. 6A and 6B show vehicle counts 156 at the roadside conductor assembly segments (counting vehicles in the conductor assembly segment is based on counting the sudden jump in power use and the amount of power used in the conductor assembly segment) and vehicle counts 158 based on the registered vehicles that passed through the roadside conductor assembly segments, and FIG. 6C shows the conductor assembly segments with discrepancies 160 between them. FIGS. 7A and 7B show vehicle counts 162 at Segment R92, and registered vehicle counts 164 that pass through Segment R92, and FIG. 7C shows the time duration 166 in which the conductor assembly segment has discrepancies between them. Any possible failures and violations will be recorded on a permanent medium also so that they will not be lost.

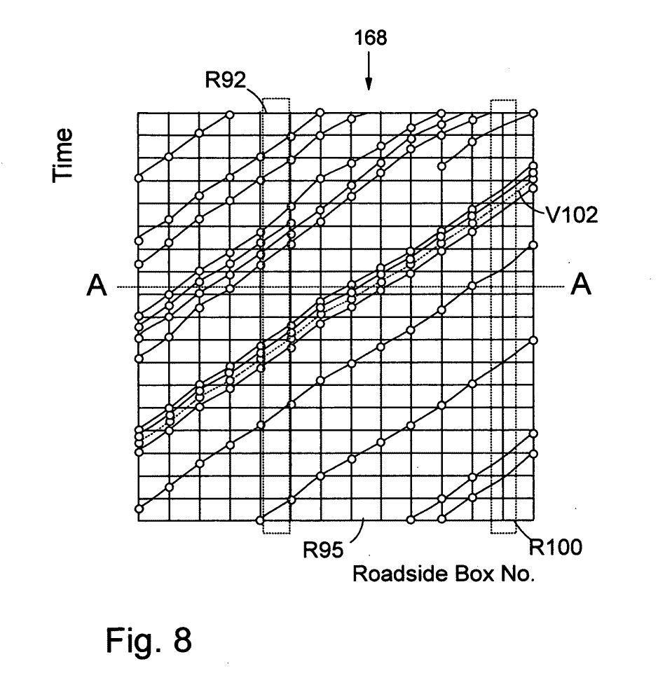

FIG. 8 shows a time-space diagram 168 created by connecting the time points at which the readings at the roadside power meter increased at the roadside conductor assembly segments. FIGS. 5A through 5C and FIGS. 6A through 6C represent meter readings and vehicle counts at time point marked by A-A of FIG. 8. Though not shown, comparison of power use between neighboring conductor assemblies, and power use per conductor in each conductor assembly segment may also be graphically shown, and if abnormally low power use for a conductor is found, it may be reported to the monitoring personnel so that a repair crew may be dispatched immediately.

In the hypothetical example shown over FIGS. 5 through 8, vehicle V102 is a violating vehicle that has entered the electrified lane without registering and the roadside conductor assembly R100 is a defective assembly that does not supply power, wherein “registered” implies that the vehicle has transmitted valid payment information to the roadside controller. The violating vehicle V102 is shown in FIG. 8 by a vehicle trajectory shown by a dotted line, and at time A-A violation (of not registering or reporting its power use) is detected by roadside conductor assembly R95. The defective roadside conductor assembly R100 is clearly distinguishable for not having any time points (or small circles) that show increase in power use as a vehicle enters into the conductor assembly segment in FIG. 8.

The failure and irregularity analysis process may be fully automated with no graphical displays. In such a case, software will interpret the cause of irregular data, and report the findings to a responsible party. In either case, if the monitoring system detects a potential problem, it can take various actions. For example, (1) if a vehicle reports a zero speed after decelerating with an abnormally steep rate or a zero speed in a region that is not congested, the monitoring system assumes that an accident or vehicle failure has occurred, and will automatically transmits a slower or zero allowable maximum speed to the roadside controllers in the immediate upstream region of the highway system, and gives an alarm to the personnel so that he/she is able to watch the scene through the monitoring camera to examine whether it is necessary to take further action, (2) if unreasonably low power use is detected in a roadside conductor, and/or conductor assembly, the monitoring system determines that a failure of the conductor and/or conductor assembly is possible, it gives an alarm so that the center personnel can send maintenance crew to the site, (3) if freezing of road surface, heavy fog, or heavy snow fall is observed or expected, the monitoring system will automatically transmits a regional allowable maximum speed to the roadside controllers in the region of the highway system, and (4) if a violator vehicle or non-registered vehicle is reported or suspected, the monitoring system will display its location and observe its activity, and if necessary will call highway patrol to apprehend the driver. In addition, the system operation monitoring center is able to report real-time traffic conditions in the electric highway to TV stations or radio stations as requested.

The system operation monitoring center sets allowable maximum speed at selected conductor assembly segments under such occasions as bad weather conditions, scheduled or unscheduled maintenance work, system failures, and accidents, and transmits it to the roadside controllers.

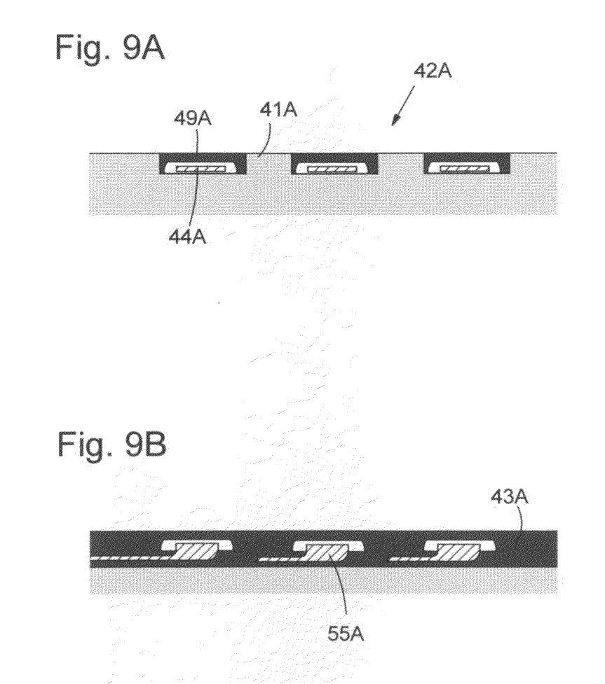

An alternative embodiment of the roadside conductor assembly 42A includes a roadside conductor assembly bed 41A and an expansion segment 43A that are alternately longitudinally disposed generally in the middle of the electrified lane. As shown in FIGS. 9A and 9B, the roadside conductor bed 41A includes at least one shallow groove cut in the pavement with at least roadside conductor 44A that is preferably a braded rectangular or flat wire covered with insulation. The conductor is laid over a layer of a caulking material such as a silicone caulking material spread over the bottom of the groove, and another layer of the caulking material spread on top of it to fully enclose the roadside conductor inside the envelope created by the caulking material. The unfilled space in the groove (or the top part of the groove) is filled with a material that does not shield magnetic field such as asphalt sealant or paved over with asphalt mix. The expansion segment 43A between two neighboring conductor beds is a shallow gutter that also connects the conductor bed and the roadside box, and contains the connecting (or looping) ends of the conductors and the terminating ends 55A of the conductors. The gutter is deeper than the grooves in the conductor bed segment. The ending portions of the conductors extend to the roadside box and connecting ends of the conductors are laid over a layer of a caulking material and covered with the same caulking material in the gutter, and paved over with asphalt mix. This alternative design of the roadside conductor housing may be used on bridges or in roadway segments that use a heavy amount of re-bars.

### Alternative Embodiment A

In this embodiment, the manually driven ordinary vehicle that is not designed to use the electrified lane in the preferred embodiment is allowed to travel on the electrified lane. The longitudinal position control of the vehicle equipped with automated operation but that happens to follow a manually operated vehicle will have to rely on the distance/speed meter during the car following mode operation.

### Alternative Embodiment B

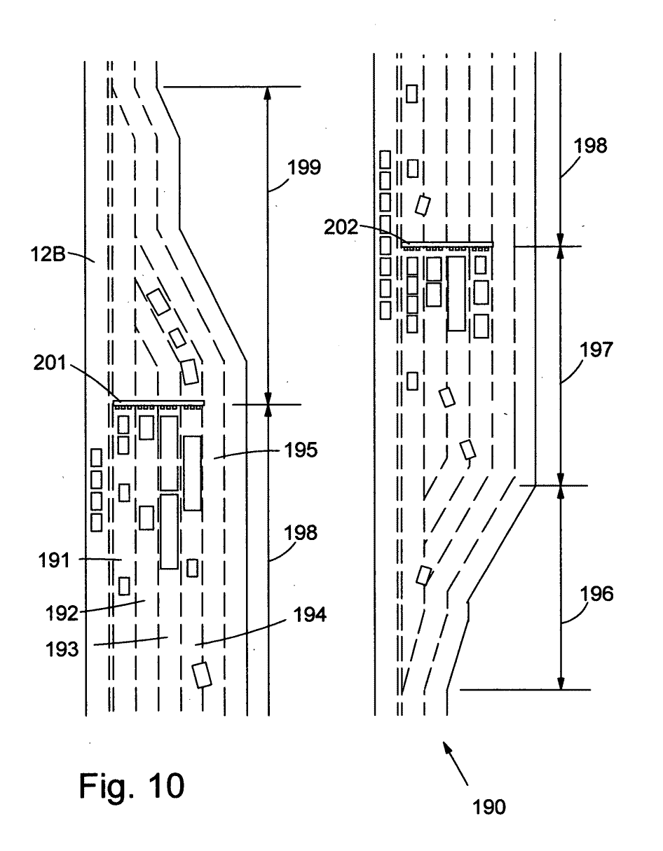

This alternative embodiment is generally identical to the preferred embodiment except that in this embodiment, coupling and decoupling of vehicles is done only at coupling/decoupling terminals. As shown in FIG. 10, the coupling/decoupling terminal 190 comprises at least one run-through electrified lane 12B in which coupled vehicles and single vehicles travel without stopping at the coupling/decoupling terminal; at least one coupling/decoupling lane for each coupler-height category vehicle (a coupling/decoupling lane for the car 191, a coupling/decoupling lane for the SUV etc. 192, and a coupling/decoupling lane for the large truck 193 in the three-category coupler system); and at least one lane for non-couplable vehicles 194; and at least one conventional traffic lane 195 in the coupling decoupling segments that are extensions of the main line lanes (as shown in FIG. 10), or that connected to on/off ramps to the coupling/decoupling terminal (not shown).

The coupling/decoupling lane comprises a turn-out segment 196, a decoupling segment 197, a coupling segment 198, and a turn-in segment 199. The turn-out segment 196 is the segment, in which coupled vehicles and vehicles that are not couplable turn out from the electrified lane to the coupling/decoupling terminal; the decoupling segment 197 is the segment in which the turned out vehicles queue up before the decoupling stop line for decoupling vehicle, and vehicles from conventional traffic lane will join the queue. The coupling segment 198 is the segment, in which some of the decoupled vehicles will leave the coupling/decoupling area to the conventional highway lanes, and those vehicles that wish to enter into the electrified lane will queue up and couple together before the coupling stop line. The turn-in segment 199 is the segment in which the coupled vehicles will turn into the electrified lane. In all of these segments, the vehicles are operated manually.

The stop line 201 for the coupling segment and the stop line 202 of the decoupling segment are equipped with traffic signals and signal controllers that include a communication means and connected to a special version of the roadside controller that is equipped with the signal controller functions. The electric highway system through the roadside controller prescreens the vehicle IDs for validity of using the electric highway system. If the vehicle is found unfit to use the electric highway system, the vehicle will be ordered to leave the coupling/decoupling area of the terminal to the conventional lane, and the vehicle ID is sent to the system operation monitoring center and the vehicles near by. At each of the stop lines, each of the lanes is given a green signal one at a time wherein the duration of the green time reflects the time needed to handle the vehicles in the queue.

### Alternative Embodiment C

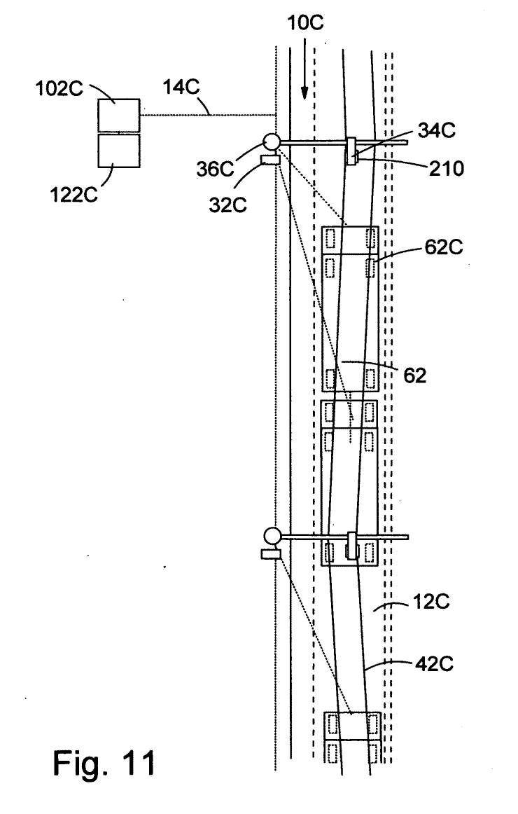

As shown in FIGS. 11 through 13, in Alternative Embodiment C of the electric highway system, the roadside conductors are overhead wires instead of conductors buried underneath the roadway pavement.

Just as in the preferred embodiment, this alternative embodiment of the electric highway includes a roadside subsystem 10C, at least one electrified lane 12C that is possibly separated by a non-elevated divider strip 16C from other lanes for ordinary traffic if the electric highway is partially electrified; a system operation monitoring center 102C; an account processing center 122C that may share the facility with the monitoring center 102C; a communication network 14C that connects the system operation monitoring center 102C, the account processing center 122C and the roadside subsystem; at least one power source such as a feeder station, and power cables that connect the power source and the roadside subsystem. The roadside subsystem 10C includes one roadside conductor assembly 42C per electrified lane; a roadside part of a lateral location sensor; a plurality of roadside posts 36C to each of which a camera 34C and a transducer type detector 210 (or detector head) are affixed; and the same number of roadside controllers 33C (as the roadside post) that include a detector card of the transducer type detector and at least one communication means and housed in a roadside box 32C.

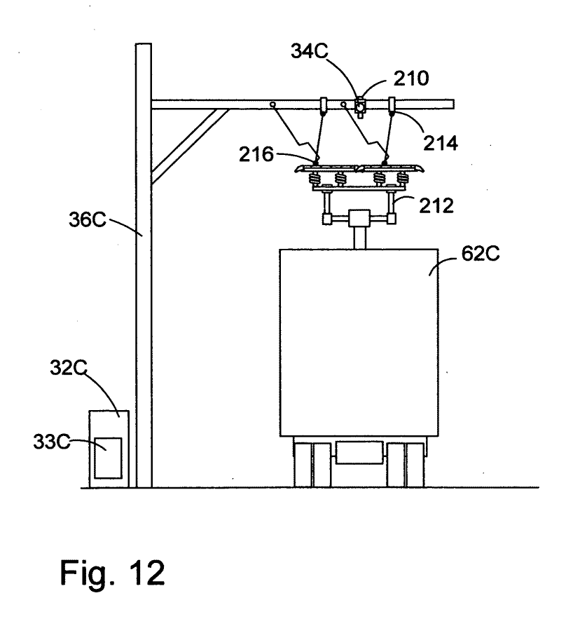

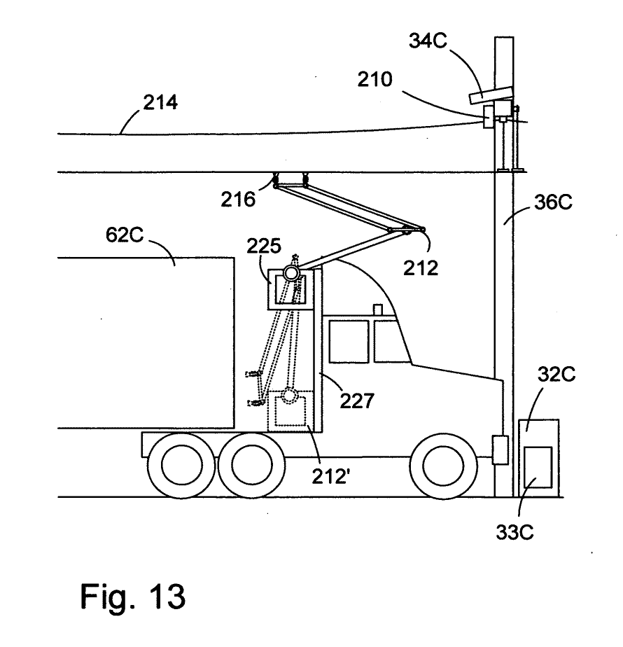

The roadside conductor assembly 42C includes a pair of catenary assemblies, wherein each of which pair includes a catenary 214 (or messenger wire) and a contact wire 216 that transfers electric power to the vehicles in the electrified lane(s). The roadside post 36C includes a vertical member (a pole) and a horizontal member from which horizontal member a segment of at least one pair of catenary assemblies is hung, and on which horizontal member a transducer type detector 210 and the camera 34C are mounted (see FIGS. 12 and 13).

As shown in FIGS. 11 and 12, the pair of the contact wires 216 is pulled laterally toward the same direction at each roadside post to form a staggered geometric pattern when seen from the sky above along the highway route. The two wires are generally kept the same distance apart that equals the distance between the lateral center points 218 of the two sliding means 220 of the pantograph assembly 212. The lateral location sensor is the same as that used in the preferred embodiment: uses a plurality of magnetic cells placed in drilled holes in the pavement along the lane markings of the electrified lane with generally equal longitudinal spacing, and on-board magnetometers.

When the pantograph assembly is in use, the base means 225 is at the top of the support frame, and when it is not in use, the pantograph assembly 212′ is lifted down by the motor and folded down, and kept behind the driver cab (see FIG. 13).

This alternative embodiment of the electric highway system is used by the vehicle of at least third type and possibly by the vehicle of fourth type. The vehicle of third type is a tall vehicle such as a large truck or bus equipped with an electric motor, at least one energy storage means, and a power pick up means assembly that takes power from the overhead wires and at least one coupler. The vehicle of fourth type is identical to the vehicle of third type except it is not equipped with the power pick up means assembly.

The payment process is generally identical to that of the preferred embodiment except that the vehicle without the power pick up assembly may take electricity through the coupler. Regarding the rate of payment, it is reasonable to assume that the vehicle that supplies the electricity to the vehicle without the power pick up means assembly would get a discount, or the vehicle that takes electricity from the coupler would have to pay extra for not carrying the power pick up means assembly.

When the vehicle in the electrified lane passes by the roadside box 32C, the vehicle transmits its current speed, acceleration/deceleration rate to the roadside controller, and in return, the roadside controller transmits the allowable maximum speed to the vehicle. Independently of this, the roadside controller 33C creates a vehicle profile for every vehicle passed under the transducer type detector 210. The detector emits a electromagnetic signal vertically downward and measures the echoing time it takes to return to the detector continuously, and thus it is able to draw a profile of every vehicle passing beneath the detector, and is able to predict whether the vehicle is equipped with the pantograph, whether the pantograph at the lifted-up state, or whether the vehicle is coupled.

When a tall vehicle with a lifted up power pick up means (pantograph), or a coupled vehicle to a tall vehicle with a lifted-up power pick up means is detected but no payment information has been sent to the roadside controller or a payment information that has been sent is not satisfactory, the camera 33C affixed to the downstream roadside post that is focused on a viewing spot will take a picture of the violator vehicle, and transmits it to the operation center 102C.

Power is fed into the roadside conductors directly to the overhead conductors from the feeder lines, and thus, no power meter readings at the roadside conductor will be sent to the system operation monitoring center. Thus the analysis at the center will involve only with data that do not include roadside power meter readings.

### Alternative Embodiment D

In another alternative embodiment, a group of vehicles of any type including those powered by conventional internal combustion engine is pulled in a train formation by a tall vehicle equipped with a power pick up means assembly. The train is assembled and disassembled at a terminal that is connected to the electrified lane by flyovers. The towed vehicles in this case do not have an account to use the electric highway, and thus the driver of the towed vehicle must pay directly to the operator of the towing vehicle for the towing service.

The towed vehicle will be temporarily furnished with a detachable coupler assembly of the alternative design with power line connectors that include front and rear couplers connected by a metal beam and an onboard lateral location sensor that is connected to the towing vehicle by electric wires for electromechanically controlled brakes and a communications means. The towed vehicle must be equipped with a brake system that can be remotely controlled from the towing vehicle and is equipped with a steering system that can be controlled by an automated steering mechanism which is mounted at the terminal by the system operator, and the vehicle will have to be made ready for affixing the coupler assembly for towing before using this system.

### Hybrid Systems of Different Embodiments

Various kinds of hybrid systems of these alternative embodiments are possible including that involves the preferred embodiment plus the Embodiment C. In this hybrid system, large trucks equipped with the mechanical couplers may use only the overhead wires and the pantograph assembly. The overhead wire system and the under the pavement conductor system embodiment may share one system operation monitoring center that operates the entire system, one communication network, and the same magnetic cells and every other roadside posts—the spacing of which posts, for example, may be set up to be about 20 meters in the preferred embodiment and about 40 meters in Alternative Embodiment C. In this case, the roadside post with the camera attached to it may be set up only for that hold the overhead wires.

The invention having been described in detail in accordance with the requirements of the U.S. Patent Statutes, various other changes and modifications will suggest themselves to those skilled in this art. It is intended that such changes and modifications shall fall within the spirit and scope of the invention defined in the appended claims.

1. An electric highway system including a roadside subsystem, a system operation monitoring center, a communication network connecting said roadside subsystem and said system operation monitoring center, and at least one electrified lane in which a plurality of vehicles equipped with an electric motor and at least one energy storage means operate wherein
said roadside subsystem includes a plurality of roadside controllers and roadside conductor assemblies,
said roadside controller is housed in a roadside box,
said roadside controller includes at least one communication means,
said roadside controller includes a power supply assembly and a power meter, and
said roadside controller transmits readings of said power meter to said system operation monitoring center continually every small time increment.

2. An electric highway system as defined in claim 1 wherein
said roadside controller electronically receives from said vehicle running in said roadside conductor assembly segment on-board meter reading, said vehicle's speed and acceleration/deceleration every time when said vehicle passes by said roadside box wherein said roadside conductor assembly segment is a segment of said electrified lane in which said roadside conductor assembly is disposed.

3. An electric highway system as defined in claim 2 wherein
said roadside controller transmits said power meter reading of said roadside conductor assembly and said on-board power meter reading, and said vehicle's speed and acceleration/deceleration to said system operation monitoring center through said communication network.

4. A roadside subsystem of an electric highway system as defined in claim 1 wherein
said system operation monitoring center is equipped with at least one graphical display means that is used to visually monitor operational status of said roadside conductor segment.

5. An electric highway system as defined in claim 1 wherein
said electric highway system is equipped with means to impose an allowable maximum speed to said vehicles operated in said electrified lane in said electric highway system.

6. An electric highway system as defined in claim 1 wherein
said roadside controller electronically receives payment information from said vehicle.

7. An electric highway system as defined in claim 1 wherein
said roadside controller electronically receives request for permission to enter into said electrified lane from said vehicle before said vehicle enters into said electrified lane.

8. An electric highway system as defined in claim 1 wherein said roadside subsystem includes roadside part of lateral location sensor wherein said lateral location sensor comprises roadside part of lateral location sensor and on-board part of lateral location sensor.

9. An electric highway system including a system operation monitoring center, at least one electrified lane in which a plurality of vehicles equipped with an electric motor and at least one energy storage means operate wherein
said roadside subsystem includes one roadside conductor assembly comprising a pair of catenary assemblies per said electrified lane, a plurality of roadside controllers wherein each of said roadside controller includes a detector card for the transducer type detector, and housed in a roadside box, and same number of roadside post as said roadside box and a communication network that connects said system operation monitoring center and said roadside controller.

10. An electric highway system as defined in claim 9 wherein
said roadside controller includes at least one communication means, and
said roadside controller electronically receives from said vehicle on-board meter reading, speed and acceleration/deceleration every time when said vehicle passes by said roadside box wherein said roadside conductor assembly segment is a segment of said electrified lane in which said roadside conductor assembly is disposed.

11. An electric highway system as defined in claim 9 wherein
said roadside post includes a vertical member and a horizontal member from which horizontal member a segment of said pair of catenary assemblies are hung, and on which horizontal member a transducer type detector and a camera are mounted.

12. An electric highway system as defined in claim 9 wherein
said system operation monitoring center is equipped with at least one display means for visually monitor operational status of said roadside conductor segment.

13. An electric highway system as defined in claim 9 wherein
said roadside subsystem is equipped with means to impose different allowable maximum speeds to said vehicles operated in said roadside assembly segment under different circumstances.

14. An electric highway system as defined in claim 9 wherein
said roadside controller receives request for permission to enter into said electrified lane from said vehicle before said vehicle enters into said electrified lane wherein said request include vehicle ID of said vehicle.

15. An electric highway system as defined in claim 9 wherein said roadside subsystem includes roadside part of a lateral location sensor.

16. An electric highway system including a roadside subsystem and at least one electrified lane wherein
said roadside subsystem includes a plurality of conductor assemblies,
said roadside conductor assembly includes a conductor bed and an expansion box,
said conductor bed and said expansion box are disposed longitudinally in an alternate order in said electrified lane, and
said conductor bed includes at least one longitudinally extending non magnetic field shielding coaxial tube assembly wherein said coaxial tube assembly comprises an internal tube and an external tube, and
said conductor is placed inside said internal tube.

17. An electric highway system as defined in claim 16 wherein
said conductor bed includes at least one longitudinally extending groove in which said non magnetic field shielding coaxial tube assembly is placed.

18. An electric highway system as defined in claim 16 wherein
said internal and external tubes of said coaxial tube assembly have a square cross section.

19. An electric highway system as defined in claim 18 wherein
said conductor in said internal tube has a square or rectangular cross section.

20. An electric highway system as defined in claim 16 wherein
said expansion box has concrete walls and a concrete cover with reinforcement steel bars or mesh, and has an opening at the bottom,
said conductor has a connecting end and an terminating end, and
said expansion box holds said connecting ends of said conductors and said terminating ends of said conductors connect said expansion box and said roadside box through said conduit.

21. An electric highway system that includes a roadside subsystem and at least one electrified lane wherein
said roadside subsystem includes a plurality of conductor assemblies,
said roadside conductor assembly includes a conductor bed and an expansion segment,
said conductor bed and said expansion segment are disposed longitudinally in an alternate order in said electrified lane,
said roadside conductor bed includes at least one roadside conductor that includes at least one braided rectangular wire or braided flat wire,
said conductor is laid over a layer of caulking material that is spread on the bottom of a shallow groove cut on pavement of said electrified lane, and another layer of said caulking material spread on top of said conductor to fully enclose said conductor in said caulking material,
space above said caulking material that encloses said conductor inside in said groove is covered with material that does not shield magnetic field,
said conductor has a connecting end and a terminating end,
said expansion segment between two neighboring said conductor beds is a shallow gutter,
said gutter is deeper than said groove in which said conductor is laid,
said expansion segment holds said connecting ends and said terminal ends of said roadside conductors, and
said expansion segment connects said conductor bed and said roadside box.
